(19) United States
(12) Patent Application Publication
(10) Pub. No.: US 2007/0002083 A1
(43) Pub. Date: Jan. 4, 2007

(54) Display of pixels via elements organized in staggered manner

(76) Inventor: Stephane Belmon, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/174,225

(22) Filed: Jul. 2, 2005

(51) Int. Cl. G09G 5/02

(52) U.S. Cl. 345/694

(57) ABSTRACT

A display has red, green, and blue elements organized in a staggered manner. Image data to be displayed on the display has a number of pixels, each pixel having a red value, a green value, and a blue value. Each element of the display is associated with at least one of the pixels, such that each pixel has associated therewith a red element, a green element, and a blue element forming a triangle overlapping triangles formed by the red, green, and blue elements associated with one or more other of the pixels. An intensity of each element of the display is set based on corresponding color values of the pixels with which the element is associated.

### BACKGROUND

Image data generated by computers and other types of computing devices is commonly considered to be made up of pixels organized in columns and rows. Each pixel has a red intensity value, a green intensity value, and a blue intensity value, which together form the color of the pixel with a given intensity. However, in actuality display devices, or displays, are not made up of pixels having collocated red, green, and blue sub-pixels. Rather, displays have physical display elements, or dots, including red elements, green elements, and blue elements, with each display element occupying its own physical place. Therefore, simply mapping a pixel of the image data to its own red, green, and blue elements of a display can result in poor image quality, since these three elements are not physically collocated within the display.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a display having red, green, and blue display elements organized in a staggered manner, in conjunction with which embodiments of the invention may be practiced.

FIG. 2 is a diagram of image data having pixels that each have a red value, a green value, and a blue value, in conjunction with which embodiments of the invention may be practiced.

FIGS. 3, 4, and 5 are diagrams depicting how the image data of FIG. 2 can be mapped to the display of FIG. 1 to display the image data on the display, according to varying embodiments of the invention.

FIG. 6 is a flowchart of a method for associating display elements of a display to pixels of image data to be displayed on the display, according to an embodiment of the invention.

FIG. 7 is a diagram of a rudimentary device in which image data is displayed via display elements that are associated with pixels of the image data, according to an embodiment of the invention.

FIG. 8 is a diagram of a representative printing device, in conjunction with which embodiments of the invention may be practiced.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

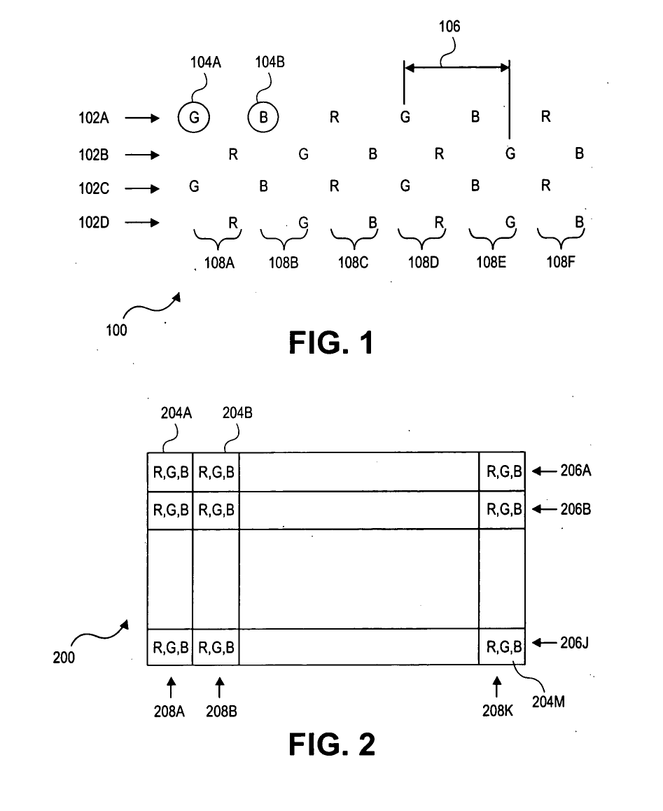

FIG. 1 shows a representative display 100, in conjunction with which embodiments of the invention may be practiced. The display 100 includes a number of display elements 104A, 104B, . . . , 104N, which are collectively referred to as the display elements 104. The display elements 104 are organized in a number of rows 102A, 102B, 102C, and 102D, collectively referred to as the rows 102, and a number of staggered columns 108A, 108B, 108C, 108D, 108E, and 108F, collectively referred to as the columns 108. Four rows 102 and six staggered columns 108 are depicted in FIG. 1, for a total of twenty-four display elements 104, for illustrative convenience. In actuality, there may typically be many more rows 102 and columns 108, such as 234 rows, with 480 display elements in each row, for a total of more than 100,000 display elements.

The display elements 104 include red, green, and blue elements. The red display elements emit red light when turned on, the green display elements emit green light when turned on, and the blue display elements emit blue light when turned on. The display elements 104 may thus include red, green, and blue light-emitting diodes (LED's), or other types of elements. Each of the display elements 104 is capable of emitting its correspondingly colored light at a variable intensity. For example, if the display 100 is an eight-bit display, each element is capable of emitting light from a value of zero, corresponding to the element emitting no light, to a value of 2⁸−1=255, corresponding to the element emitting maximum light.

The display elements 104 are organized in a staggered manner within the display 100 as to their location within the display 100. In particular, each of the rows 102 is made up of a repeating series of red, green, and blue elements, with adjacent of the rows 102 having repeating series of display elements being shifted, or staggered, relative to one another by one-and-a-half display elements. For example, the row 102A has two series of red, green, and blue elements in the order green-blue-red, green-blue-red. The series within the row 102B that corresponds to the second green-blue-red series of elements within the row 102A is thus shifted by one-and-a-half display elements to the right, as indicated by the arrow 106.

The rows 102A and 102C can be considered odd rows, and the rows 102B and 102D can be considered even rows, such that the even rows have repeating series of display elements being shifted, or staggered, relative to the odd rows by one-and-a-half elements, and vice-versa. The rows 102 are depicted in FIG. 1 as having repeating series of display elements in the order green-blue-red. However, the rows 102 may have repeating series of display elements in other orders, in other embodiments of the invention. For instance, these different orders can be: green-red-blue, blue-green-red, blue-red-green, red-green-blue, and red-blue-green.

Furthermore, within any given of the columns 108, it can be said that adjacent of the rows 102 are staggered relative to one another by half an element. Thus, the first display element of the row 102A is a green element, and the first display element of the row 102B is a red element that is shifted to the right by one-half of an element in its location. As before, the rows 102A and 102C can be considered odd rows, and the rows 102B and 102D can be considered even rows, such that the even rows have elements that are shifted, or staggered, relative to the odd rows by one-half of an element in their locations, and vice-versa.

FIG. 2 shows representative image data 200, according to an embodiment of the invention. The image data 200 is made up of pixels 204A, 204B, . . . , 204M, which are collectively referred to as the pixels 204. The pixels 204 are typically, and as depicted in FIG. 2 specifically, organized in a number of rows 206A, 206B, . . . , 206J, collectively referred to as the rows 206, and a number of columns 208A, 208B, . . . , 208K, collectively referred to as the columns 208. There may be more or less rows 206 as compared to columns 208. The pixels 204 may further be organized in ways other than within rows 206 and columns 208, in other embodiments of the invention.

Each of the pixels 204 has a red value, a green value, and a blue value. Each of the red value, the green value, and the blue value of a given pixel corresponds to a corresponding intensity of that color for this pixel, with a value from zero to 2ⁿ−1, where n is the bit-depth of the image data 200. For instance, a sixteen-bit depth of the image data 200 results in each of the red, green, and blue values of each pixel ranging from zero to 65535. The red, green, and blue values of each pixel combined represent the color of the pixel. That is, where red, green, and blue light have intensities corresponding to the red, green, and blue values of a pixel are combined, the resulting color is the color of the pixel.

The pixels 204 of the image data 200 of FIG. 2 are abstract constructs in relation to the display elements 104 of the display 100 of FIG. 1. That is, the image data 200 presumes that red, green, and blue light can be collocated in the same place, such that, for a given pixel, red, green, and blue light can be combined at a given location corresponding to the pixel, at intensities corresponding to the red, green, and blue values of the pixel. However, none of the display elements 104 are in actuality collocated in the same place, so the image data 200 cannot be displayed in this manner on the staggered display 100. Rather, the red, green, and blue elements 104 each occupy its own place within the display 100. Therefore, embodiments of the invention are concerned with how to map image data pixels to display elements, or how to associate display elements with image data pixels. Three different approaches for such mapping or associating are now described.

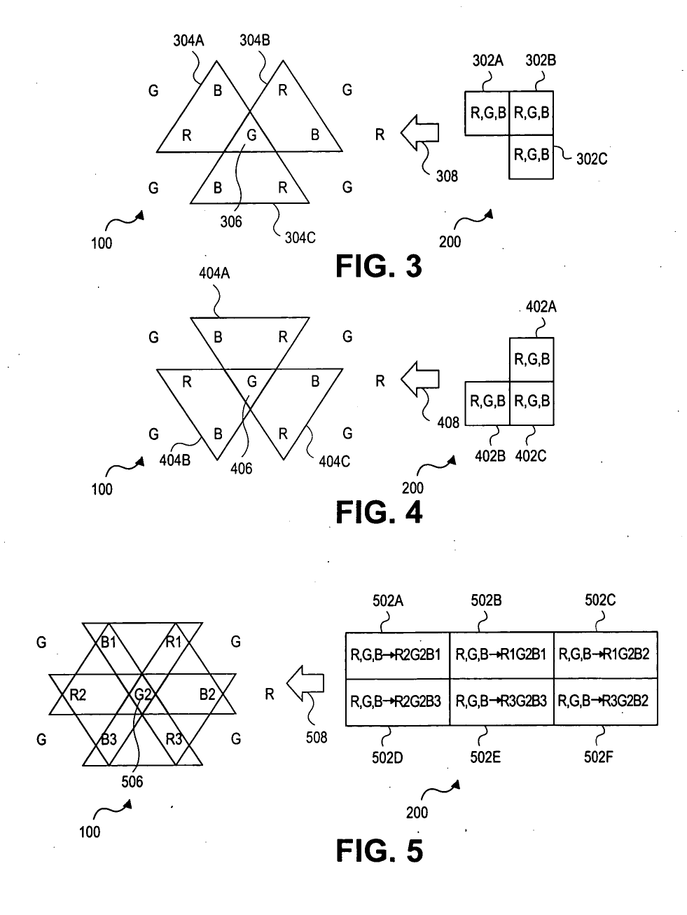

FIG. 3 shows one manner by which pixels of the image data 200 are mapped to elements of the display 100, and thus how display elements are associated with image data pixels, according to an embodiment of the invention. On the right side of FIG. 3, three particular pixels 302A, 302B, and 302C of the image data 200 are depicted, which are collectively referred to as the pixels 302. On the left side of FIG. 3, three groupings, or more particularly triangles, of display elements 304A, 304B, and 304C of the display 100 are depicted, and which are collectively referred to as the triangles of display elements 304. The pixels 302 are thus mapped to the triangles 304, as indicated by the arrow 308. The mapping of the pixels 302 to the triangles of display elements 304 is representative of how all the pixels of the image data 200 are mapped to the display elements of the display 100.

More specifically, the pixel 302A is mapped to the triangle 304A of display elements, the pixel 302B is mapped to the triangle 304B of display elements, and the pixel 302C is mapped to the triangle 304C of display elements. All of the triangles 304 are oriented in the same direction, with two corners at the bottom and one corner at the top. The triangles 304 overlap with one another at the green element 306. Each of the triangles 304 encompasses a red element, a blue element, and the green element 306, which correspond to the red, blue, and green values of the pixel that has been mapped to this triangle. The green element 306 thus is associated with three pixels 302 of the image data 200. The intensity of the green element 306 is set based on the green values of the pixels 302 with which it is associated. In particular, the intensity of the green element 306 may be the average value of the green values of the pixels 302.

FIG. 3 therefore shows how three representative pixels 302 are mapped to representative triangles 304 of display elements, and how a display element 306 is associated with these pixels 302. The example of FIG. 3 can thus be extended to all of the pixels 204 of the image data 200 of FIG. 2, and to all of the display elements 104 of the display 100 of FIG. 1, to display the image data 200 on the display 100. For instance, a pixel to the right of the pixel 302B and a pixel to the right of the pixel 302C can be mapped to triangles that overlap the blue element of the triangle 304B and that are oriented in the same direction as the triangles 304, such that this blue element is associated with three triangles. The intensity of this blue element is set based on the pixels that are mapped to the element, and more specifically is the average value of the blue values of the pixels that are mapped to the element.

With the mapping approach of FIG. 3, each of the display elements 104 of the display 100 of FIG. 1 is associated with at most three of the pixels 204 of the image data 200 of FIG. 2. More particularly, each of the display elements 104 is typically associated with three of the pixels 204, except for the display elements 104 located on the edges of the display 100. The intensity of each display element is set based on the corresponding color values of the pixels with which the display element is associated. More particularly, the intensity of each display element is set to the average value of the corresponding color values of the pixels with which the display element is associated. The triangle of display elements to which each of the pixels 204 is mapped encompasses a red element, a green element, and a blue element.

FIG. 4 shows another manner by which pixels of the image data 200 are mapped to elements of the display 100, and thus how display elements are associated with image data pixels, according to an embodiment of the invention. On the right side of FIG. 4, three particular pixels 402A, 402B, and 402C of the image data 200 are depicted, which are collectively referred to as the pixels 402. On the left side of FIG. 4, three groupings, or triangles, of display elements 404A, 404B, and 404C of the display 100 are depicted, and which are collectively referred to as the triangles of display elements 404. The pixels 402 are mapped to the triangles 404, as indicated by the arrow 408. The mapping of the pixels 402 to the triangles of display elements 404 is representative of how all the pixels of the image data 200 are mapped to the display elements of the display 100.

The embodiment of FIG. 4 differs from the embodiment of FIG. 3 in the orientation of the triangles to which pixels of the image data 200 are mapped. In FIG. 3, the triangles 304 are each oriented so one corner is on the top and two corners are on the bottom. By comparison, in FIG. 4, the triangles 404 are each oriented so two corners are on the top and one corner is on the bottom. The triangles 404 are thus also all oriented in the same direction. As in FIG. 3, the pixels 402 are each mapped to one of the triangles 404 in FIG. 4 such that each pixel is mapped to a red element, a green element, and a blue element. Furthermore, in FIG. 4, as in FIG. 3, each of the display elements of the display 100 is associated with at most three pixels, and each display element is typically associated with three pixels, except for display elements on the edges of the display 100.

For instance, the green element 406 is associated with all of the pixels 402, such that all of the pixels 402 are mapped to triangles 404 that encompass the green element 406. That is, the triangles 404 overlap one another at the green element 406. The intensity of the green element 406 is based on the green values of the pixels 402. In particular, the intensity of the green element 406 can be set equal to the average value of the green values of the pixels 402.

The example of FIG. 4 can be extended to all of the pixels 204 of the image data 200 of FIG. 2, and to all of the display elements 104 of the display 100 of FIG. 1, to display the image data 200 on the display 100. For instance, a pixel to the right of the pixel 402A and a pixel to the right of the pixel 402C can be mapped to triangles that overlap the blue element of the triangle 404C and that are oriented in the same direction as the triangles 404, such that this blue element is associated with three triangles. The intensity of this blue element is set based on the pixels that are mapped to the element, and more specifically is the average value of the blue values of the pixels that are mapped to this blue element.

FIG. 5 shows a third manner by which pixels of the image data 200 are mapped to elements of the display 100, and thus how display elements are associated with image data pixels, according to an embodiment of the invention. On the right side of FIG. 5, six particular pixels 502A, 502B, 502C, 502D, 502E, and 502F of the image data 200 are depicted, which are collectively referred to as the pixels 502. On the left side of FIG. 5, six groupings, or triangles of display elements of the display 100 are depicted. For illustrative clarity, these triangles are not specifically called out in FIG. 5. The pixels 502 are mapped to these triangles, as indicated by the arrow 508. The mapping of the pixels 502 to the triangles of display elements is representative of how all the pixels of the image data 200 are mapped to the display elements of the display 100.

The individual triangle to which each of the pixels 502 is mapped is indicated in FIG. 5 by the constituent elements of that triangle. For example, the pixel 502A is indicated as being mapped to the red element R1, the green element G2, and the blue element B1 in FIG. 5, such that it is mapped to the triangle encompassing the display elements R1, G2, and B2. Similarly, the pixel 502B is mapped to the triangle encompassing the display elements R1, G2, and B1; the pixel 502C is mapped to the triangle encompassing the elements R1, G2, and B2; and, the pixel 502D is mapped to the triangle encompassing the elements R2, G2, and B3. Finally, the pixel 502E is mapped to the triangle encompassing the display elements R3, G2, and B3; and the pixel 502F is mapped to the triangle encompassing the elements R3, G2, and B2.

The difference between the embodiment of FIG. 5 and the embodiments of FIGS. 3 and 4 is two-fold. First, in the embodiments of FIGS. 3 and 4, each of the triangles 304 and 404 are oriented in the same direction of the other of the triangles 304 and 404, respectively. By comparison, in the embodiment of FIG. 5, the triangles thereof include triangles that have a single corner on the top, as in FIG. 3, as well as triangles that have a single corner on the bottom, as in FIG. 4. The embodiment of FIG. 5 may thus be considered the conjunctive combination of the embodiments of FIGS. 3 and 4, such that both triangles having single corners on the top, as in FIG. 3, and triangles having single corners on the bottom, as in FIG. 4, are employed.

Second, in the embodiment of FIGS. 3 and 4, each of the display elements of the display 100 is associated with at most, and typically is associated with, three of the pixels of the image data 200. By comparison, in the embodiment of FIG. 5, each of the display elements of the display 100 is associated with at most, and typically is associated with, six of the pixels of the image data 200. For instance, the green element 506 is associated with all of the pixels 502, such that all of the pixels 502 are mapped to triangles that encompass, and overlap at, the green element 506. The intensity of the green element 506 is based on the green values of the pixels 502. In particular, the intensity of the green element 506 can be set equal to the average values of the green values of the pixels 502.

The approach to mapping pixels to display elements, and thus to associating display elements with pixels of FIG. 5 allows for more pixels to be mapped to the same number of display elements as compared to the approaches of FIGS. 3 and 4. For example, if the display 100 of FIG. 1 includes 480 by 234 display elements, then the embodiment of FIG. 5 allows image data 200 having nearly double the number of pixels as the number of display elements, or nearly 960 by 468 pixels, to be displayed on the display 100. By comparison, the embodiments of FIGS. 3 and 4 allow image data 200 having nearly the same number of pixels as the number of display elements, or nearly 480 by 234 pixels, to be displayed on the display 100.

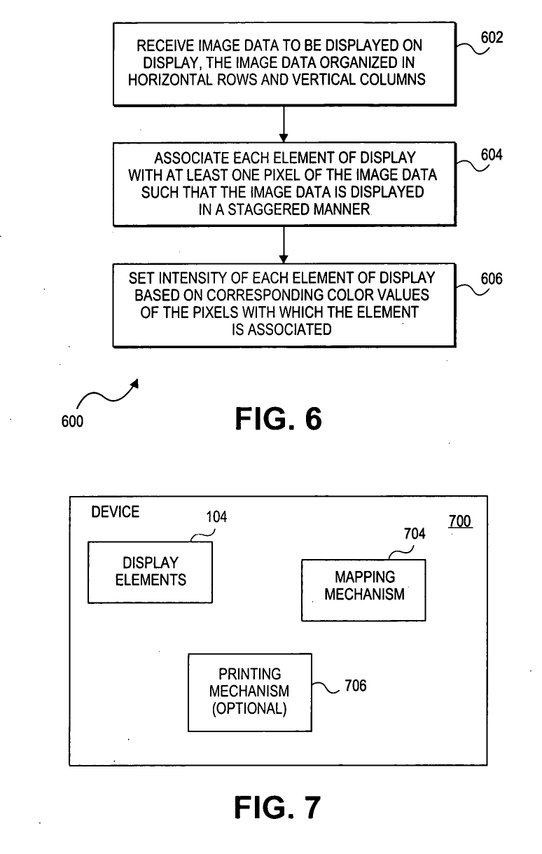

FIG. 6 shows a method 600 for displaying the pixels 204 of the image data 200 of FIG. 2 on the display 100 having the display elements 104 of FIG. 1, according to an embodiment of the invention. The method 600 may be implemented as one or more computer program parts of a computer program stored on a computer-readable medium. The computer program parts may be different subroutines, routines, software objects, and so on, of a computer program. The computer-readable medium may be a volatile or a non-volatile computer-readable medium, and may further be a magnetic medium, such as a hard disk drive, an optical medium, such as an optical disc, and/or a semiconductor medium, such as a memory.

First, the image data 200 to be displayed on the display 100 is received (602). The image data 200 is organized in horizontal rows and vertical columns in one embodiment. Furthermore, as has been described, the display elements 104 of the display 100 are organized in a staggered manner, and include red, green, and blue elements. The display 100 may be that which has been shown in and described in conjunction with FIG. 1. As has also been described, each of the pixels 204 of the image data 200 has a red value, a green value, and a blue value.

Each of the display elements 104 of the display 100 is associated with at least one of the pixels 204 of the image data 200 (604). Thus, the image data 200 is displayed in a staggered manner. Such association may be accomplished as has been shown in and described in conjunction with FIG. 3, FIG. 4, or FIG. 5. Thus, each of the pixels 204 is associated with, or is mapped to, a red element, a green element, and a blue element of the display 100, where these three elements form a triangle that overlap triangles formed by the red, green, and blue element associated with other of the pixels 204 of the image data 200. The triangles may be all oriented in the same or an identical direction, such that each of the display elements 104 of the display 100 is associated with at most three of the pixels 204, as in FIGS. 3 and 4. Alternatively, each of the display elements 104 may be associated with at most six of the pixels 204, as in FIG. 5.

The intensity of each of the display elements 104 of the display 100 is finally set based on the corresponding color values of those of the pixels 204 of the image data 200 with which the display element is associated (606), as has been exemplarily described in conjunction with FIGS. 3, 4, and 5. For example, a green display element has its intensity set based on the green values of the pixels with which this element has been associated. In one embodiment, the intensity of each display element is set equal to the average value of the corresponding color values of the pixels associated with the element. For example, a green display element may have its intensity set equal to the average value of the green values of the pixels with which this element has been associated.

FIG. 7 shows a rudimentary device 700, according to an embodiment of the invention. The device 700 includes the display elements 104, and thus may be considered to include the display 100 of FIG. 1 that has been described. The device 700 further includes a mapping mechanism 704, which may be implemented in software, hardware, or a combination of hardware and software. The device 700 may optionally include a printing mechanism 706 where the device 700 is a printing device, such as an inkjet-printing device or a laser-printing device. The printing mechanism 706 is hardware, or a combination of hardware and software, that allows the device 700 to form images on media, such as sheets of paper. As can be appreciated by those of ordinary skill within the art, the device 700 may and typically does include additional components, in addition to and/or in lieu of those depicted in FIG. 7.

The display elements 104 of the device 100 are organized in a staggered manner, as has been described in conjunction with FIG. 1, and include red, green, and blue elements, each of which has an intensity, or an intensity value. The mapping mechanism 704 is to set the intensity values of the display elements 104 based on image data having pixels, such as the image data 200 having the pixels 208 of FIG. 2. Each of the display elements 104 is associated with at least one of the pixels, in one of the manners that has been described in relation to FIGS. 3, 4, and 5. Thus, the mapping mechanism 704 can be considered as being the part of the device 700 that performs the method 600 of FIG. 6 in one embodiment. Each pixel has associated therewith a red element, a green element, and a blue element forming a triangle that overlaps the triangles formed by the red, green, and blue elements associated with one or more other pixels.

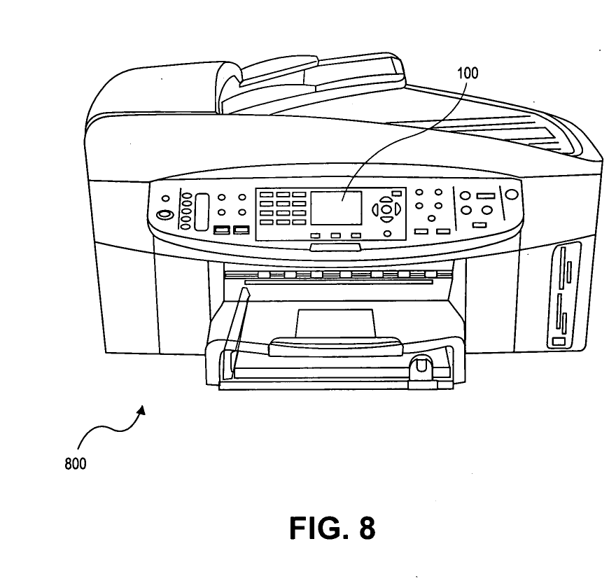

FIG. 8 shows a representative printing device 800, in conjunction with which embodiments of the invention may be practiced. The printing device 800 is a particular example of the device 700 of FIG. 7. The printing device 800 includes a printing mechanism that is not specifically depicted and/or called out in FIG. 8. The printing device 800 further includes the display 100 of FIG. 1 that has been described. As such, image data like the image data 200 of FIG. 2 can be displayed on the display 100 of the printing device 800, as has been described in relation to FIGS. 3, 4, 5, and 6. The display 100 may be used as part of a user interface for the printing device 800, in conjunction with which a user may set printing options, view images to be printed on the device 800, and receive status information and alerts from the device 800.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

I claim:

1. A method comprising:
receiving image data to be displayed on a display, the display having a plurality of elements organized in a staggered manner, including red, green, and blue elements, the image data having a plurality of pixels organized in horizontal rows and vertical columns, each pixel having a red value, a green value, and a blue value;
associating each element of the display with at least one of the pixels, such that each pixel has associated therewith a red element, a green element, and a blue element forming a triangle overlapping triangles formed by the red, green, and blue elements associated with one or more other of the pixels; and,
setting an intensity of each element based on corresponding color values of the pixels with which the element is associated.

2. The method of claim 1, wherein the triangles formed by the red, green, and blue elements are all oriented in an identical direction, such that each element of the display is associated with at most three of the pixels.

3. The method of claim 1, wherein each element of the display is associated with at most six of the pixels.

4. The method of claim 1, wherein the elements of the display are organized in the staggered manner such that each of a plurality of rows of elements of the display has a repeating series of a red element, a green element, and a blue element, and odd rows of elements have the repeating series shifted by one-and-a-half elements as compared to even rows of elements.

5. The method of claim 4, wherein the repeating series of a red element a green element and a blue element consists of one of: a red element followed by a blue element followed by a green element; a red element followed by a green element followed by a blue element; a blue element followed by a red element followed by a green element; a blue element followed by a green element followed by a red element; a green element followed by a blue element followed by a red element; and, a green element followed by a red element followed by a blue element.

6. The method of claim 1, wherein setting the intensity of each element of the display based on the corresponding color values of the pixels associated with the element comprises setting an intensity of each element of the display equal to an average value of the corresponding color values of the pixels associated with the element.

7. A device comprising:
a plurality of display elements organized in a staggered manner, including red, green, and blue elements, each display element having an intensity value; and,
a mechanism to set the intensity values of the display elements based on image data having a plurality of pixels, each display element associated with at least one of the pixels, such that each pixel has associated therewith a red element, a green element, and a blue element forming a triangle overlapping triangles formed by the red, green, and blue elements associated with one or more other of the pixels.

8. The device of claim 7, wherein the display elements are organized in the staggered manner such that each of a plurality of rows of elements of the display has a repeating series of a red element, a green element, and a blue element, and odd rows of display elements have the repeating series shifted by one-and-a-half display elements as compared to even rows of display elements.

9. The device of claim 7, wherein each display element has at most three of the pixels associated therewith.

10. The device of claim 7, wherein the mechanism is to set the intensity value of each display element equal to an average value of corresponding color values of the pixels associated with the display element.

11. The device of claim 7, wherein each of the display elements is a light-emitting diode (LED).

12. The device of claim 7, further comprising a printing mechanism, such that the device is a printing device.

13. A device comprising:
a plurality of display elements organized in a staggered manner, including red, green, and blue elements, each display element having an intensity value; and,
means for setting the intensity values of the display elements based on image data having a plurality of pixels, each display element associated with at least one of the pixels, such that each pixel has associated therewith a red element, a green element, and a blue element forming a triangle overlapping triangles formed by the red, green, and blue elements associated with one or more other of the pixels.

14. The device of claim 13, wherein the display elements are organized in the staggered manner such that each of a plurality of rows of elements of the display has a repeating series of a red element, a green element, and a blue element, and odd rows of display elements have the repeating series shifted by one-and-a-half display elements as compared to even rows of display elements.

15. The device of claim 13, wherein the means is for setting the intensity value of each display element equal to an average value of corresponding color values of the pixels associated with the display element.

16. The device of claim 13, further comprising a printing mechanism, such that the device is a printing device.

17. A computer-readable medium having a computer program stored thereon comprising:
a first computer program part to receive image data to be displayed on a display, the display having a plurality of elements organized in a staggered manner, including red, green, and blue elements, the image data having a plurality of pixels, each pixel having a red value, a green value, and a blue value;
a second computer program part to associate each element of the display with at least one of the pixels, such that each pixel has associated therewith a red element, a green element, and a blue element forming a triangle overlapping triangles formed by the red, green, and blue elements associated with one or more other of the pixels; and,
a third computer program part to set an intensity of each element of the display based on corresponding color values of the pixels with which the element is associated.

18. The computer-readable medium of claim 17, wherein the second computer program part of the computer program is to associate each element of the display is associated with at most three of the pixels.

19. The computer-readable medium of claim 17, wherein the elements of the display are organized in the staggered manner such that each of a plurality of rows of elements of the display has a repeating series of a red element, a green element, and a blue element, and odd rows of elements have the repeating series shifted by one-and-a-half elements as compared to even rows of elements.

20. The computer-readable medium of claim 17, wherein the third computer program part of the computer program is to set the intensity of each element of the display equal to an average value of the corresponding color values of the pixels associated with the element.
